(19) United States
(12) Patent Application Publication
(10) Pub. No.: US 2026/0342080 A1
(43) Pub. Date: Oct. 29, 2026

(54) ELECTRICAL GENERATION SYSTEM FOR AIRCRAFT, AND ASSOCIATED METHOD

(71) Applicants: SAFRAN, Paris (FR); SAFRAN ELECTRICAL & POWER, BLAGNAC (FR)

(72) Inventors: Geoffrey BEGGIORA, MOISSY-CRAMAYEL (FR); Florent Jean-Arnaud ROUGIER, MOISSY-CRAMAYEL (FR); Guillaume François Daniel BIDAN, MOISSY-CRAMAYEL (FR); Anne Marie LIENHARDT, MOISSY-CRAMAYEL (FR)

(21) Appl. No.: 19/123,482

(22) PCT Filed: Oct. 24, 2023
(86) PCT No.: PCT/EP2023/079627

§ 371 Date: Apr. 23, 2025

(30) Foreign Application Priority Data
Nov. 8, 2022 (FR) FR2211603

(51) Int. Cl. H02J 1/102; B64D 27/33; H02J 105/30

(52) U.S. Cl. CPC H02J 1/102; B64D 27/33; H02J 2105/32

(57) ABSTRACT

An electrical generation system for powering at least one aircraft electrical network, including a control device configured to determine a first parameterization setting for a first supply path and a second parameterization setting for a second supply path, the control device being configured to determine a first power target and a second power target from a first generation setting if the first generation setting is a power instruction; a selection unit is configured to select by default the second power target as the first power setting and select the first power target as the first power setting in case of a malfunction of the second supply path.

### TECHNICAL FIELD OF THE INVENTION

The present invention relates to an electrical generation system for an aircraft. and, more generally, an electric hybridization system for an aircraft.

The climate change is a major concern for many legislative and regulatory members around the world. Various restrictions on carbon emissions have been, are being or will be adopted by different countries. In particular, an ambitious standard applies both to new types of aircraft and to those already in circulation, requiring the implementation of technological solutions to bring them into line with current regulations. For several years now, the civil aviation has been working to help combat climate change.

Technological research efforts have already led to very significant improvements in the environmental performance of aircraft. The Applicant takes into account the starting factors in all phases of design and development to obtain aeronautical components and products that consume less energy, are more environmentally friendly and whose integration and use in civil aviation have moderate environmental consequences with the aim of improving the energy efficiency of aircraft.

This ongoing research and development work focuses in particular on new generations of hybrid thermal and electric aircraft engines. The Applicant's objective is to develop aircraft incorporating a high-power electrical generation system. This would make it possible to increase the proportion of electrical equipment on board to reduce fuel consumption.

In practice, in a conventional aircraft turbomachine, it is known to integrate an electrical generator which takes mechanical energy from the low-pressure shaft of the aircraft turbomachine to produce electrical energy which is distributed to an electrical energy distribution unit.

In order to increase the generation of electrical energy, with reference to FIG. 1, an electrical generation system 100 is proposed, configured so as to draw, on the one hand, mechanical energy from a low-pressure shaft BP and, on the other hand, mechanical energy from a high-pressure shaft HP of an aircraft turbomachine T in order to supply an electrical network of the aircraft REA with a calibrated distribution voltage. In other words, the electrical generation system 100 has at least two supply paths, in this case a LP path and an HP path. The electrical generation system 100 can also be connected to BAT electrical sources or LOAD electrical loads.

In practice, the electrical generation system 100 is configured to receive a generation setting P_{ECU}; from a calculator ECU of the turbomachine T. This generation setting P_{ECU} allows to determine, for example, the amount of electrical power to be generated, the mechanical load on each shaft, and so on.

In other words, the generation setting P_{ECU} is used to determine the hybridization strategy chosen.

With reference to FIG. 2, the electrical generation system 100 comprises two generators G1, G2 connected respectively to the low-pressure shaft BP and the high-pressure shaft HP of the turbomachine T. The electrical generation system 100 also comprises two converters C1. C2. in particular the inverters, which are respectively associated with the two generators G1, G2. Each generator G1, G2 generates an alternating current which is then rectified by its converter C1, C2 to supply a distribution voltage V_{DC} to an electrical distribution unit EDU which is electrically connected to the electrical network of the aircraft REA, the electrical sources BAT or the electrical loads LOAD.

In this example, an application related to electricity generation is presented, but the invention applies more generally to the field of hybridization in which an electrical machine performs, on the one hand, a generator function to draw mechanical power from the low-pressure shaft BP or the high-pressure HP shaft and, on the other hand, an engine function to inject mechanical power onto the low-pressure shaft BP or the high-pressure shaft HP. For an engine function, each converter C1, C2 can also convert the DC voltage V_{DC} to supply alternating current to the two electrical machines G1, G2, respectively, to inject power.

For the sake of clarity and brevity, only the generating function is presented. For an engine function, the calculator ECU provides a P_{ECU} injection setting to determine, for example, the injection of mechanical power on each shaft, and so on. The hybridization system is bi-directional to enable the generation of electrical power as well as the injection of mechanical power.

In a known manner, each converter C1, C2 comprises a plurality of switches, in particular power transistors, which allow to modify the electrical power generated and the electrical power drawn by each generator G1, G2 from each shaft BP, HP. The electrical generation system 100 comprises a control device 200 for issuing parameterization settings P_{CONS1}, P_{CONS2} to each converter C1, C2 as a function of the generation setting P_{ECU} so as to obtain a distribution voltage V_{DC} which is adapted to the electrical distribution unit EDU.

In the prior art, with reference to FIGS. 3 to 5, several control devices 200a, 200b, 200c are known for supplying the parameterization setting P_{CONS1}, P_{CONS2} to the converters C1, C2 of each supply path V1, V2.

With reference to FIG. 3, a control device 200a is known comprising a first regulation unit 201a and a second regulation unit 202a which respectively supply power settings P_{BP*}, P_{HP*} to a first processing unit 203a and to a second processing unit 204a as a function of the generation setting P_{ECU}. In this way, each regulation unit 201a, 202a can independently implement the hybridization strategy determined by the generation setting P_{ECU}. The first processing unit 203a and the second processing unit 204a respectively supply the parameterization settings P_{CONS1}, P_{CONS2} to the first converter C1 and the second converter C2 from the power settings P_{BP*}, P_{HP*}. In this example, each regulation unit 201a, 202a performs independent control for each converter C1, C2 by comparing the distribution voltage V_{DC} with a distribution voltage setting V_{DC*} while taking into account the generation setting P_{ECU}. In this example, the supply paths V1 and V2 are symmetrical.

Although this “decentralised” architecture is simple and robust, it has the disadvantage of generating a non-zero static error. For example, the distribution voltage V_{DC} supplied to the electrical distribution unit EDU depends on the load level of the electrical distribution unit EDU, which requires templates that cover a wide range of variation. This increases the cost and complexity of the EDU. In addition, such regulation is highly dependent on the measurement of the VDC distribution voltage, which means that the chain for acquiring the measurement of the VDC distribution voltage must be highly accurate. This adds to the cost and complexity.

With reference to FIG. 4, a control device 200b is also known, comprising a sharing unit 201b which provides a first parameterization setting P_{CONS1} to the first converter C1 as a function of the generation setting P_{ECU}. Similarly to FIG. 3, the control device 200b comprises a regulation unit 202b and a processing unit 203b. The regulation unit 202b performs independent regulation by comparing a measurement of the distribution voltage V_{DC} with a distribution voltage setting V_{DC*} to provide a power setting P_{HP*}. The processing unit 203b supplies the parameterization setting P_{CONS2} to the second converter C2 as a function of the power setting P_{HP*}. In this example, the supply paths V1 and V2 are asymmetrical.

This other “decentralized” architecture has the advantage of ensuring independence between the 201b sharing unit on the one hand and the regulation unit 202b and the processing unit 203b on the other. Nevertheless, such an architecture is not very robust in the event of the loss of the regulation unit 202b and/or the processing unit 203b. The sharing unit 201b can reconfigure itself over an “electrically” long period of time, which can lead to a partial power failure. In addition, the sharing unit 201b must constantly receive a generation setting P_{ECU} in order to operate.

With reference to FIG. 5, it is also known that a control device 200c comprises a regulation unit 202c which compares a measurement of the distribution voltage V_{DC} with a distribution voltage setting V_{DC*} to provide a power setting P_{HP*}. The control device 200c comprises a sharing unit 201c which provides the parameterization settings P_{CONS1}, P_{CONS2} to the converters C1, C2 as a function of the generation setting P_{ECU} and the power setting P_{HP*}. In this example, the supply paths V1 and V2 are symmetrical.

This “centralized” architecture has the advantage of being robust in the event of loss of the regulation unit 202c or partial operation of the sharing unit 201c. Such an architecture has the disadvantage of requiring rapid communication, greater than 10 kHz, between the regulation unit 202c and the sharing unit 201c to transmit the power setting P_{HP*}. To achieve this aim, it is necessary to provide a calculation unit dedicated to ensure the transmission of the power setting P_{HP*} between the regulation unit 202c (generation side HP) and the sharing unit 201c (generation side BP), which increases the calculation requirements and raises the cost.

The purpose of the invention is to propose an electrical generation system which eliminates at least some of these disadvantages.

US20180291807A1 and US2021380264A1 teach a system and a method to allocate electrical power to an aircraft.

### SUMMARY OF THE INVENTION

The invention relates to an electrical generation system for supplying at least one electrical network of an aircraft, the aircraft comprising at least one aircraft turbomachine comprising a low-pressure shaft and a high-pressure shaft configured to be driven in rotation, the electrical generation system being configured so as to receive a general generation setting defining a hybridization strategy, the electrical generation system comprising:
A first supply path comprising:
   A first generator configured to generate an alternating current by drawing mechanical energy from one of the low-pressure and high-pressure shafts,
   A first converter, associated with the first generator, for converting the alternating current generated into a first distribution current as a function of its parameterization, the first converter generating a first power which is a function of a distribution voltage,
A second supply path comprising:
   A second generator configured to generate an alternating current by drawing mechanical energy from the other of the low-pressure and high-pressure shafts,
   A second converter, associated with the second generator, for converting the alternating current generated into a second distribution current as a function of its parameterization, the second converter generating a second power which is a function of the distribution voltage,
A control device configured to determine a first parameterization setting for the first converter and a second parameterization setting for the second converter, the control device comprising:
A control block configured, on the basis of the general generation setting, to supply a first generation setting to the first supply path and a second generation setting to the second supply path, one of the first generation setting and the second generation setting being a voltage instruction and the other being a power instruction,
   A first control path for controlling the first supply path which comprises:
   A regulation unit configured to determine a first power target as a function of a distribution voltage setting and a measure of the distribution voltage,
   A hybridization unit configured to determine a second power target from the first generation setting,
   A selection unit configured to, whether the first generation setting is a power instruction,
      Select by default the second power target as the first power setting and
      Select the first power target as the first power setting in case of a malfunction of the second supply path,
   A processing unit configured to determine the first parameterization setting for the first converter from the first power setting.

Advantageously, the second power target corresponds to a power target that enables the hybridization strategy to be respected. The first power target is determined by the voltage regulation and corresponds to a back-up target when the hybridization strategy can no longer be met. Advantageously, the second power target can be transmitted over a slow communication line, with the first power target being able to take over reactively in the event of a malfunction. Advantageously, the control block allows the power control for one of the supply paths, which is dynamically adapted in the event of a malfunction of the other supply path.

In addition, there is no need for a high-speed communication line, as the supply paths can be reconfigured on the fly.

Preferably, the selection unit is configured so as, if the first generation setting is a voltage instruction, to select the first power target as the first power setting. In this way, a more secure voltage control is accepted on request. Only power control can be modified in the event of degraded operation.

According to one aspect, the electrical generation system comprises at least one electrical distribution unit supplied by the converters at the distribution voltage. The distribution unit is preferably in the form of a bus.

According to one aspect, the control block also belongs to the electrical distribution unit. The distribution unit's computing resources are then pooled.

Preferably, the control device comprises a second control path for controlling the second supply path which comprises:
A regulation unit configured to determine a first power target as a function of a distribution voltage setting and a measurement of the distribution voltage,
A hybridization unit configured to determine a second power target from the second generation setting.
A selection unit configured to:
   If the second generation setting is a voltage instruction, select the first power target as the second power setting,
   If the second generation setting is a power instruction, select by default the second power target as the second power setting and select the first power target as the second power setting in the event of a malfunction of the first supply path,
A processing unit configured to determine the second parameterization setting for the second converter from the second power setting,

Preferably, the first control path and the second control path have similar units. This enables decentralised control.

According to one aspect, the electrical generation system comprises:
At least one third supply path comprising a third converter, supplied by a third electrical source, for generating a third distribution current as a function of its parameterization, the third converter generating a third power which is a function of the distribution voltage,
The control device being configured to determine a third parameterization setting for the third converter, the control device comprising a third control path for controlling the third supply path.
The control block being configured, on the basis of the generation general setting, to supply a third generation setting to the third supply path, a single generation setting being a voltage instruction, the others being power instructions.

The electrical generation system is thus scalable to more than two paths to implement complex hybridization strategies.

According to one aspect, the selection unit of the first control path is configured to:
If the first generation setting is a power instruction, select by default the second power target as the first power setting and select the first power target as the first power setting in case of a malfunction of the second supply path or the third supply path.

In this way, the first supply path takes account of the operating state of the other supply paths before applying a power instruction, which improves reliability.

Preferably, each generator is in the form of an electrical machine configured to inject mechanical energy onto one of the low-pressure and high-pressure shafts (engine function). The converter, associated with the generator is a bidirectional converter.

The invention also relates to an electrical generation method for supplying at least one electrical network of an aircraft from an electrical generation system as presented previously, the aircraft comprising at least one aircraft turbomachine comprising a low-pressure shaft and a high-pressure shaft configured to be driven in rotation, the method comprising the steps of:
Receiving a general generation setting defining a hybridization strategy,
From the generation general setting, supplying a first generation setting to the first supply path and a second generation setting to the second supply path, one of the first generation setting and the second generation setting being a voltage instruction, the other being a power instruction,
Determining a first power target as a function of a distribution voltage setting and a distribution voltage measurement,
Determining a second power target from the first generation setting,
Selecting by default the second power target as the first power setting and selecting the first power target as the first power setting in case of a malfunction of the second supply path,
Determining a first parameterization setting for the first converter from the first power setting.

The invention also relates to a product of the computer program type, comprising at least one sequence of instructions stored and readable by a processor and which, once read by this processor, causes the steps of the method as presented above to be carried out.

The invention also relates to a computer-readable medium comprising the computer program product as presented above.

### PRESENTATION OF FIGURES

The invention will be better understood on reading the following description, given by way of example, with reference to the following figures, given by way of non-limiting examples, wherein identical references are given to similar objects.

FIG. 1 is a schematic representation of an electrical generation system drawing mechanical energy from an aircraft turbomachine.

FIG. 2 is a schematic representation of the electrical generation system with its generators, its converters, an electrical distribution unit and a control device.

FIG. 3 is a schematic representation of a first embodiment of a control device according to the prior art.

FIG. 4 is a schematic representation of a second embodiment of a control device according to the prior art.

FIG. 5 is a schematic representation of a third embodiment of a control device according to the prior art.

FIG. 6 is a schematic representation of an electrical generation system according to the invention.

FIG. 7 is a schematic representation of the control device of the generation system.

FIG. 8 is a detailed schematic representation of a regulation unit of the control device.

FIG. 9 is a schematic representation of the operation of the first selection unit of the first control path.

FIG. 10 is a schematic representation of a further embodiment of the generation system with a third supply path.

FIG. 11 is a schematic representation of another form of embodiment of the generation system.

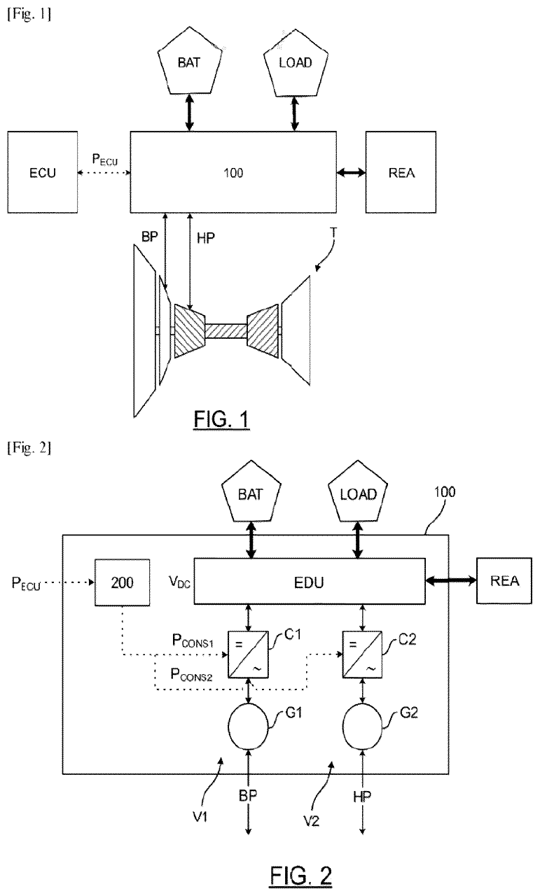

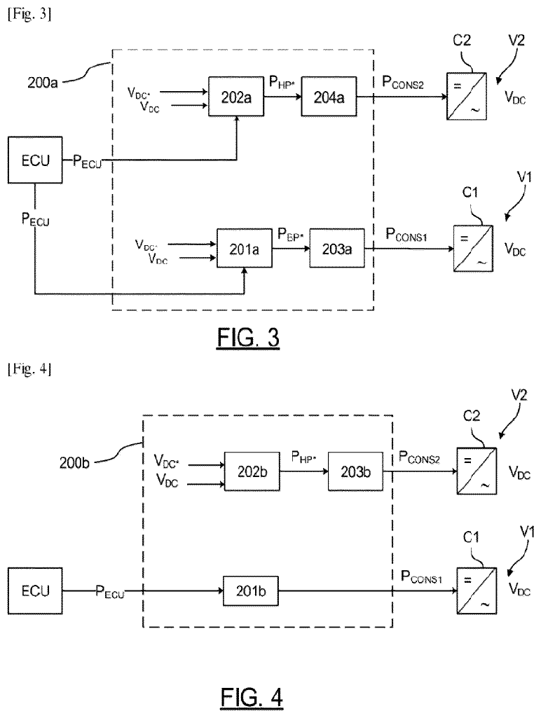

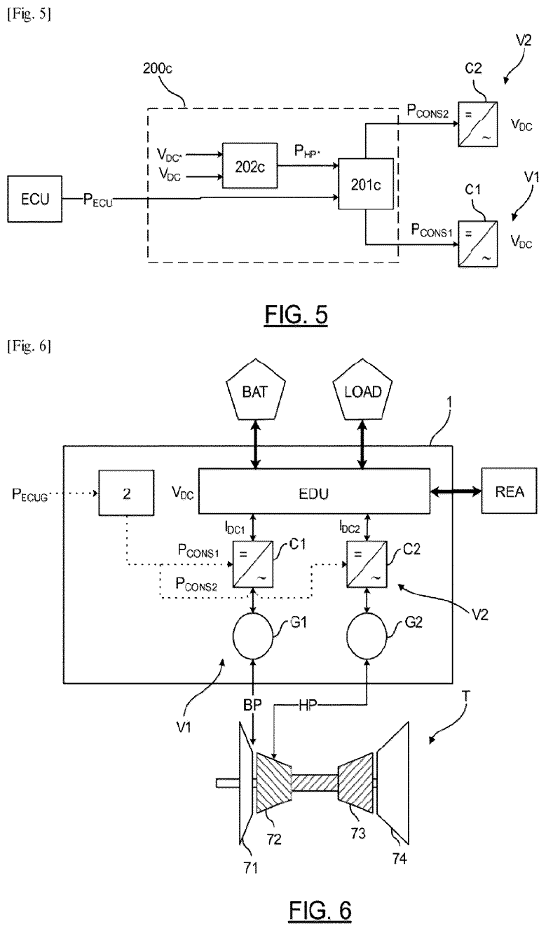

It should be noted that the figures set out the invention in detail in order to implement the invention, said figures of course being able to be used to better define the invention if necessary.

### DETAILED DESCRIPTION OF THE INVENTION

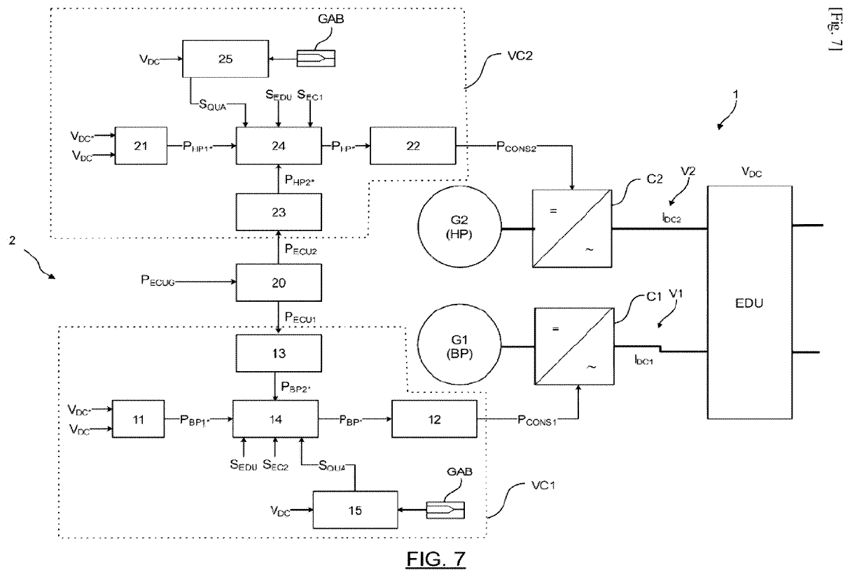

With reference to FIG. 6, an electrical generation system 1 for an aircraft is shown. The aircraft comprises a turbomachine T comprising a low-pressure BP shaft and a high-pressure shaft HP. In this example, the turbomachine T comprises a low-pressure compressor 71 and a low-pressure turbine 74 which are connected by the low-pressure shaft BP and a high-pressure compressor 72 and a high-pressure turbine 73 which are connected by the high-pressure shaft HP.

The electrical generation system 1 is configured to draw mechanical energy on one hand, from the low-pressure shaft BP and on the other hand, mechanical energy from the high-pressure shaft HP in order to supply a calibrated voltage to an electrical network of the aircraft REA. The electrical generation system 1 can also be connected to BAT electrical sources or LOAD electrical equipment to be supplied.

In practice, as will be explained below, the electrical generation system allows more generally an electrical hybridization to allow power to be drawn from or injected into the turbomachine T.

The electrical generation system 1 is configured to receive a general generation setting P_{ECUG} from a calculator ECU of the turbomachine T. This general generation setting P_{ECUG} is used to determine, for example, the amount of electrical power to be generated, the mechanical load on each shaft, etc.

In other words, the general generation setting P_{ECUG} is used to determine the hybridization strategy chosen. In practice, the general generation setting P_{ECUG} takes the form of a power setting known as the “Setting PS” or a power sharing setting known as the “Mode PS”.

With reference to FIGS. 6 and 7, the electrical generation system 1 comprises two generators G1, G2 connected respectively to the low-pressure shaft BP and the high-pressure shaft HP of the turbomachine T. The electrical generation system 1 comprises:
A first supply path V1 comprising:
   A first generator G1 configured to generate an alternating current by drawing mechanical energy from the low pressure shaft BP,
   A first converter C1, associated with the first generator G1, for converting the alternating current generated into a first distribution current I_{DC1} as a function of its parameterization, the first converter C1 generating a first power P_{BP} which is a function of a distribution voltage V_{DC},
A second supply path V2 comprising:
   A second generator G2 configured to generate an alternating current by drawing mechanical energy from the high-pressure shaft HP,
   A second converter C2, associated with the second generator G2, to convert the alternating current generated into a second distribution current I_{DC2} as a function of its parameterization, the second converter C2 generating a second power P_{HP} which is a function of the distribution voltage V_{DC}.

In this example, the first supply path V1 is associated with a power take-off from a low-pressure shaft BP while the second path V2 is associated with a power take-off on a high-pressure shaft HP. Of course, the reverse is also possible.

In this example, the G1, G2 are preferably electrical machines capable of operating in generator mode or motor mode. In a known way, each electrical machine comprises a rotor secured to a rotating shaft (in this case a shaft BP or a shaft HP) and a stator comprising windings so as to generate three-phase alternating currents. Preferably, the speed w and angular position θ of each generator G1, G2 are available. The structure and the operation of such an electrical machine are well known and will not be discussed in further details.

With reference to FIG. 6, the electrical generation system 1 comprises an electrical distribution unit EDU which is electrically connected to the electrical network of the aircraft REA, electrical sources BAT or electrical loads LOAD.

Each converter C1, C2 can supply a distribution voltage V_{DC} to the electrical distribution unit EDU. Preferably, the electrical distribution unit EDU comprises a voltage bus.

In a known way, each converter C1, C2 comprises a plurality of switches, in particular transistors, which enable the electrical power generated and the mechanical power drawn from each shaft BP, HP to be modified in order to adapt the distribution current I_{DC1}, I_{DC2} as required.

According to the invention, with reference to FIG. 6, the electrical generation system 1 comprises a control device 2 configured to determine a first parameterization setting P_{CONS1} for the first converter C1 and a second parameterization setting P_{CONS2} for the second converter C2.

Preferably, each parameterization setting P_{CONS1}, P_{CONS2} is in the form of a pulse width modulation signal (MLI). This parameterization P_{CONS1}, P_{CONS2} is used to control the switching of the transistors of the converters C1, C2.

With reference to FIG. 7, the control device 2 comprises a control block 20 configured, on the basis of the general generation setting P_{ECUG}, to supply a first generation setting P_{ECU1} to the first supply path V1 and a second generation setting P_{ECU2} to the second supply path V2. According to the invention, one of the first generation setting P_{ECU1} and the second generation setting P_{ECU2} is a voltage instruction InsV while the other is a power instruction InsP. A power instruction InsP aims to comply with a criterion for supplying or drawing power via a supply path V1, V2 (power setting, power sharing, etc.) whereas a voltage instruction InsV is intended to provide simple voltage regulation without the objective of hybridization.

Advantageously, the generation settings P_{ECU1}, P_{ECU2} are of different natures in order to control the supply paths V1, V2 asymmetrically while having a control device 2 which comprises control paths VC1, VC2 which are similar, as will be shown later.

Thus, depending on the situation over time, the type of instruction supplied to each of the supply paths V1, V2 may change following a modification of the general generation setting P_{ECUG}, the generation settings P_{ECU1}, P_{ECU2} remaining of different natures.

With reference to FIG. 7, the control device 2 comprises, for the first supply path V1, a first control path VC1 which comprises a regulation unit 11 configured to determine a first power target P_{BP1*} as a function of a distribution voltage setting V_{DC*} and a measurement of the distribution voltage V_{DC}. According to one aspect of the invention, the first regulation unit 11 implements a regulation loop with zero static error using a corrector, for example of the proportional-integral type PI, in order to determine a first power target P_{BP1*} as a function of the distribution voltage setting V_{DC*} and the measurement of the distribution voltage V_{DC}. In practice, the first power target P_{BP1*} is determined in a similar way to the prior art.

Still referring to FIG. 7, the first control path VC1 comprises a hybridization unit 13 configured to determine a second power target P_{BP2*} from the first generation setting P_{ECU1} Preferably, the hybridization unit 13 allows to determine an alternative target to the first power target P_{BP1*}.

In practice, the hybridization unit 13 determines the second power target P_{BP2} as a function of the nature of the setting P_{ECU1} which may be directly the target power setting to be applied or a formula depending on P_{ECU1} as a function of the hybridization strategy.

The second power target P_{BP2*} corresponds to a power target that enables the hybridization strategy to be respected. The first power target P_{BP1*} is determined by the voltage regulation and corresponds to a back-up target in case of a malfunction, as will be explained later.

The first control path VC1 comprises a selection unit 14 configured to:
If the first generation setting P_{ECU1} is a voltage instruction InsV, select the first power target P_{BP1*} as the first power setting P_{BP*},
if the first generation setting P_{ECU1} is a power instruction InsP, select by default the second power target P_{BP2*} as the first power setting P_{BP*} and to select the first power target P_{BP1*} as the first power setting P_{BP*} in case of a malfunction of the second supply path V2.

An example of the implementation of a selection of a power target in the first control path VC1 is shown in FIG. 9.

First of all, the selection unit 14 is configured to test the instruction of the first generation setting P_{ECU1}. If the first generation setting P_{ECU1} is a voltage instruction InsV, the first power target P_{BP1*} is selected as the first power setting P_{BP*}. A voltage instruction InsV is intrinsically more secure than a power instruction InsP, and the latter can be applied securely even in case of a malfunction of the other supply path V2.

If the first generation setting P_{ECU1} is a power instruction InsP, the selection unit 14 is configured to test for the presence of a malfunction of the second supply path V2, in particular, by obtaining the operating state S_{EDU} of the electrical distribution unit EDU and the operating state S_{EC2} of the second converter C2. Advantageously, each operating state S_{EDU}, S_{EC2} can be transmitted via discrete signals (on/off signal) in order to reconfigure the first power supply path V1 to a voltage instruction InsV which is intrinsically more secure. Discrete transmission is faster than a bus.

The first power target P_{BP1*} is selected as the first power setting P_{BP*} in the presence of a malfunction of the second supply path V2 or loss of the operating states S_{EDU}, S_{C2}. This allows to obtain a secure power setting even in the event of a malfunction. In this way, the two supply paths V1, V2 can perform voltage control.

The second power target P_{BP2*} is selected as the first power setting P_{BP*} in the absence of a malfunction of the second supply path V2. This provides a power setting that enables optimum hybridization.

With reference to FIGS. 7 and 9, optionally, the selection unit 14 is configured to use the first power target P_{BP1*} in the event of detection of a non-quality signal S_{QUA} of the distribution voltage V_{DC}. To this end, with reference to FIG. 7, the control device 2 comprises a distribution monitoring unit 15 configured to compare the measurement of the distribution voltage V_{DC} over time with a voltage gauge GAB. In a known way, a voltage gauge GAB determines the authorized nominal range of variation of the distribution voltage V_{DC} as well as exceptional ranges of variation during which the distribution voltage V_{DC} can leave the nominal range of variation for a maximum authorized duration. If the distribution voltage measurement V_{DC} does not comply with the voltage gauge GAB, a non-quality signal S_{QUA} is sent by the distribution monitoring unit 15 to use the first power target P_{BP1*}. Thus, even if no malfunction of the EDU has been detected, the distribution monitoring unit 15 can activate the emergency target if the distribution voltage V_{DC} is degraded. This improves the performance of the control device 2.

In this example, the selection unit 14 is configured to use the first power target P_{BP1*} or the second power target P_{BP2*}. In practice, the selection unit 14 can also select the second power target P_{BP2*} by saturating the first power target P_{BP1*} in order to reach the second power target P_{BP2*}.

When the second power target P_{BP2*} is selected as the first power setting P_{BP*}, the first regulation unit 11 implements an anti-windup function so as not to alter the power setting P_{BP1*}.

With reference to FIG. 7, the first control path VC1 also comprises a processing unit 12 configured to determine the first parameterization setting P_{CONS1} for the first converter C1 from the first power setting P_{BP*}.

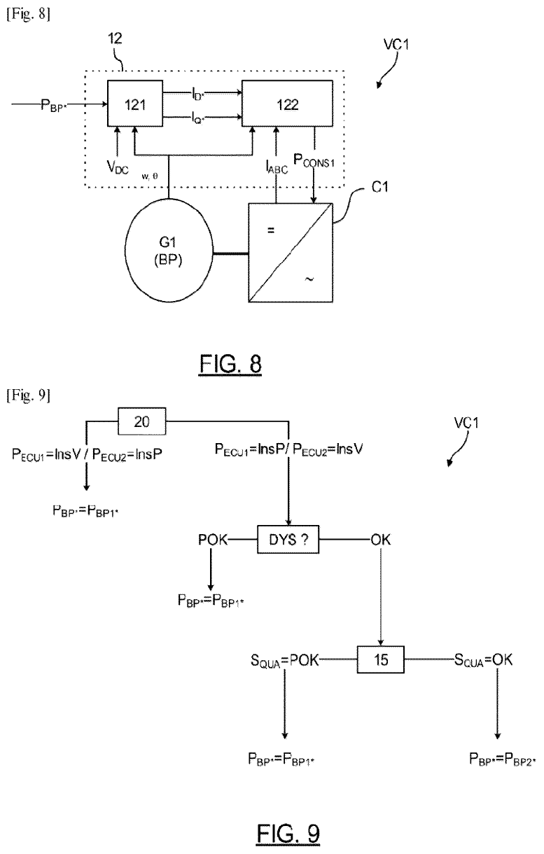

According to one aspect, with reference to FIG. 8, the processing unit 12 comprises a first block 121 implementing an algorithm transforming the first power setting P_{BP*} into two current settings I_{D}*/I_{Q}* while taking into account the speed w and the angular position θ of the first generator G1 and the measurement of the distribution voltage V_{DC}. Still with reference to FIG. 8, the first processing unit 12 also comprises a second block 122 implementing a current loop configured to define the first parameterization setting P_{CONS1} of the first converter C1 from a measurement of the three-phase currents I_{ABC} in the first converter C1 and the current settings I_{D}*/I_{Q}* from the first block 121. Such a processing unit 12 is known to the person skilled in the art and will not be presented in greater detail.

With reference to FIG. 7, the control device 2 comprises a second control path VC2 for the second supply path V2 which has units similar to the first control path VC1. Therefore, for the sake of clarity and brevity, the elements specific to the second supply path V2 will not be described again in detail.

The second control path VC2 thus comprises a regulation unit 21 configured to determine a first power target P_{HP1*} as a function of a distribution voltage setting V_{DC*} and a measurement of the distribution voltage V_{DC}.

The second control path VC2 comprises a hybridization unit 23 configured to determine a second power target P_{HP2*} from the second generation setting P_{ECU2}.

The second control path VC2 comprises a selection unit 24 configured to:
if the second generation setting P_{ECU2} is a voltage instruction InsV, select the first power target P_{HP1*} as the second power setting P_{HP*},
if the second generation setting P_{ECU2} is a power instruction InsP, select by default the second power target P_{HP2*} as the second power setting P_{HP*} and select the first power target P_{HP1*} as the second power setting P_{HP*} in case of a malfunction of the first supply path V1, in particular, by obtaining the operating state S_{EDU} of the electrical distribution unit EDU and the operating state S_{EC1} of the first converter C1.

The second control path VC2 comprises a processing unit 22 configured to determine the second parameterization setting P_{CONS2} for the second converter C2 from the second power setting P_{HP*}.

The control device 2 enables decentralised control in which the second supply path V2 is controlled autonomously, the second supply path V2 adapting to the operating state of the first supply path V1.

In this embodiment, similarly to the first control path VC1, the second control path VC2 comprises a distribution monitoring unit 25.

This example shows an application related to electrical generation, but the invention applies more generally to the field of hybridization in which an electrical machine fulfils, on the one hand, a generator function for taking mechanical power from the low pressure shaft BP or from the high pressure shaft HP and, on the other hand, an engine function for injecting mechanical power onto the low pressure shaft BP or onto the high pressure shaft HP. For an engine function, each converter C1, C2 can also convert the DC voltage V_{DC} to supply alternating current to the two electrical machines G1, G2 respectively in order to inject power.

For the sake of clarity and brevity, only the generating function is presented. For an engine function, the calculator ECU supplies an injection setting P_{ECU} allowing, for example, the injection of mechanical power on each shaft to be determined, etc. The hybridization system is bidirectional to enable the generation of electrical power but also the injection of mechanical power.

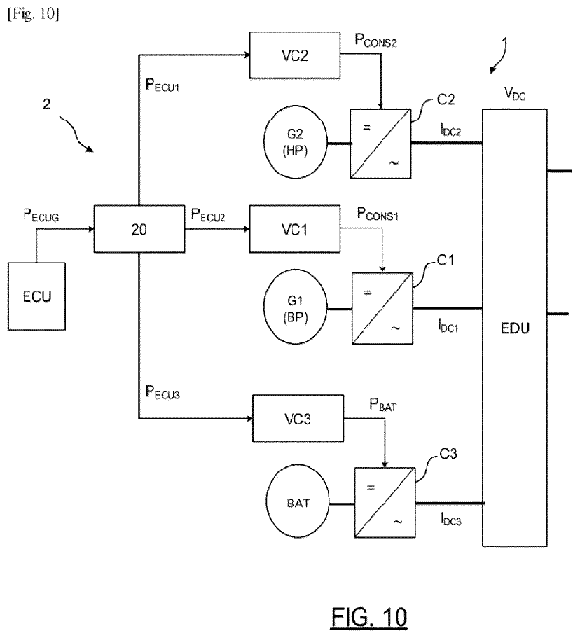

The invention has been presented for an electrical generation system 1 comprising two supply paths V1, V2 but the invention also applies in the presence of one or more other supply paths V3, in particular an electrical battery BAT, supplying a third distribution intensity I_{DC3}, to the electrical distribution unit EDU as illustrated in FIG. 10. For the sake of clarity, the second supply path V2 is not shown in this diagram.

With reference to FIG. 10, the electrical generation system 1 comprises an electrical battery BAT electrically connected to the electrical distribution unit EDU by a third converter C3, here of the DC/DC type.

The control device 2 is configured to determine a third parameterization setting P_{BAT} for the third converter C3. To this end, the control device 2 comprises a third control path VC3 for determining the third parameterization setting P_{BAT} for controlling the third supply path V3 as a function of the generation setting P_{ECU}.

In this embodiment, with reference to FIG. 10, the control block 20 is configured, on the basis of the general generation setting P_{ECUG}, to additionally supply a third generation setting P_{ECU3} to the third supply path V3. Preferably, a single generation setting is a voltage instruction InsV, the others being power instructions InsP. In this way, the general generation setting P_{ECUG} allows to handle hybridization with several supply paths V1, V2, V3 by imposing a power instruction InsP on two of the supply paths, with the last supply path adapting with voltage control.

According to one aspect, the first control path VC1 is configured in order, if the first generation setting P_{ECU1} is a power instruction InsP, to select by default the second power target P_{BP2*} as the first power setting P_{BP1*} and select the first power target P_{BP1*} as the first power setting P_{BP*} in case of a malfunction of the second supply path V2 or of the third supply path V3. In this way, malfunctions can be monitored for all other supply paths.

The control device 2 can thus be scaled and allows more than two power sources supplying the electrical distribution unit EDU to be taken into account.

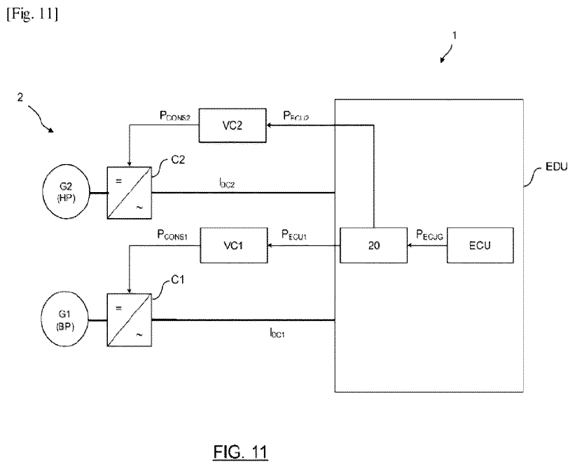

In the embodiment shown in FIG. 7, the control block 20 has been represented schematically independently of the electrical distribution unit EDU. Alternatively, with reference to FIG. 11, the control block 20 is integrated into the electrical distribution unit EDU so as to optimise computing resources. Advantageously, this allows to form an electrical distribution unit EDU which fulfils its conventional function and also supplies generation settings without having to use additional calculation resources other than those of the electrical distribution unit EDU.

The electrical generation system 1 comprises a decentralised architecture in which each control path VC1, VC2 is analogous and can make its own decisions as a function of malfunctions and/or the quality of the distribution voltage V_{DC}. Reconfigurations of the electricity generation system 1 can be carried out on the fly when malfunctions appear/disappear.

1. An electrical generation system for supplying at least one electrical network of an aircraft, the aircraft comprising at least one aircraft turbomachine comprising a low-pressure shaft and a high-pressure shaft configured to be driven in rotation, the electrical generation system being configured to receive a general generation setting defining a hybridization strategy, the electrical generation system comprising:
a first supply path comprising:
a first generator configured to generate an alternating current by drawing mechanical energy from one of the low pressure and high pressure shafts,
a first converter, associated with the first generator, for converting the alternating current generated into a first distribution current as a function of its parameterization, the first converter generating a first power which is a function of a distribution voltage,
a second supply path comprising:
a second generator configured to generate an alternating current by drawing mechanical energy from the other of the low-pressure and high-pressure shafts,
a second converter, associated with the second generator, for converting the alternating current generated into a second distribution current as a function of its parameterization, the second converter generating a second power which is a function of the distribution voltage,
a control device configured to determine a first parameterization setting for the first converter and a second parameterization setting for the second converter, the control device comprising:
a control block configured, on a basis of the general generation setting, to supply a first generation setting to the first supply path and a second generation setting to the second supply path, one of the first generation setting and the second generation setting being a voltage instruction, the other being a power instruction,
a first control path for controlling the first supply path which comprises:
a regulation unit configured to determine a first power target as a function of a distribution voltage setting and a measure of the distribution voltage,
a hybridization unit configured to determine a second power target from the first generation setting,
a selection unit configured to, whether the first generation setting is a power instruction,
select by default the second power target as the first power setting and
select the first power target as the first power setting in case of a malfunction of the second supply path,
a processing unit configured to determine the first parameterization setting for the first converter from the first power setting.

2. The electrical generation system according to claim 1, wherein the selection unit is configured to, if the first generation setting is a voltage instruction, select the first power target as the first power setting.

3. The electrical generation system according to claim 1, further comprising at least one electrical distribution unit supplied by the first converter and the second converter at the distribution voltage.

4. The electrical generation system according to claim 3, wherein the control block belongs to the electrical distribution unit.

5. The electrical generation system according to claim 1, wherein the control device comprises a second control path for controlling the second supply path which comprises:
a regulation unit configured to determine a first power target as a function of a distribution voltage setting and a measurement of the distribution voltage,
a hybridization unit configured to determine a second power target from the second generation setting,
a selection unit configured to:
if the second generation setting is a voltage instruction, select the first power target as the second power setting, and
if the second generation setting is a power instruction, select by default the second power target as the second power setting and select the first power target as the second power setting in the event of a malfunction of the first supply path, and
a processing unit configured to determine the second parameterization setting for the second converter from the second power setting.

6. The electrical generation system according to claim 5, wherein the first control path and the second control path have similar units.

7. The electrical generation system according to claim 1, further comprising:
at least one third supply path comprising a third converter, supplied by a third electrical source, for generating a third distribution current as a function of its parameterization, the third converter generating a third power which is a function of the distribution voltage,
the control device being configured to determine a third parameterization setting for the third converter, the control device comprising a third control path for controlling the third supply path.
the control block being configured, on a basis of the generation general setting, to supply a third generation setting to the third supply path, a single generation setting being a voltage instruction, the others being power instructions.

8. The electrical generation system according to claim 7, wherein the selection unit of the first control path is configured to:
if the first generation setting is a power instruction, select by default the second power target as the first power setting and select the first power target as the first power setting in case of a malfunction of the second supply path or the third supply path.

9. An electrical generation method for supplying the at least one electrical network of the aircraft from the electrical generation system according to claim 1, the method comprising:
receiving the general generation setting defining the hybridization strategy,
from the general generation setting, supplying the first generation setting to the first supply path and the second generation setting to the second supply path, one of the first generation setting and the second generation setting being the voltage instruction, the other being the power instruction,
determining the first power target as a function of the distribution voltage setting and a measurement of the distribution voltage,
determining the second power target from the first generation setting,
selecting by default the second power target as the first power setting and selecting the first power target as the first power setting in case of a malfunction of the second supply path, and
determining the first parameterization setting for the first converter from the first power setting.

10. A product of the computer program type, comprising at least one sequence of instructions stored and readable by a processor and which, when read by this processor, causes the steps of the method of claim 9 to be carried out.
